(19) United States
(12) Patent Application Publication
(10) Pub. No.: US 2024/0386773 A1
(43) Pub. Date: Nov. 21, 2024

(54) SKILL-BASED GAMING DEVICE AND PROCESSES FOR USING SAME

(71) Applicant: Primero Games, LLC, Norcross, GA (US)

(72) Inventors: Michael Mayo Macke, Norcross, GA (US); Mark C. Nizdil, Norcross, GA (US)

(21) Appl. No.: 18/667,745

(22) Filed: May 17, 2024

Related U.S. Application Data
(60) Provisional application No. 63/503,049, filed on May 18, 2023.

(51) Int. Cl. G07F 17/32

(52) U.S. Cl. CPC G07F 17/3213; G07F 17/3262; G07F 17/3267; G07F 17/3295

(57) ABSTRACT

Systems and methods are provided for administering skill-based wagering games. A gaming device can generate an outcome of a wagering game including a plurality of indicia. The gaming device can determine that a particular combination of indicia of the plurality of indicia are positioned along a pay line. In response to determining that a particular combination of indicia is positioned along the pay line, the gaming device can render a second plurality of indicia including at least two indicia corresponding to one indicium in the particular combination of indicia. The gaming device can receive a selection of a particular indicium of the second plurality of indicia. In response to determining that the particular indicium being one of the at least two indicia, the gaming device can render a user interface indicating a matching of the at least two indicia and award a matching bonus.

### CROSS-REFERENCE TO RELATED APPLICATIONS

This application claims the benefit of, and priority to, U.S. Provisional Patent Application No. 63/503,049, filed May 18, 2023 and entitled “Skill-Based Gaming Device and Processes for Using Same,” which is hereby incorporated herein by reference in its entirety.

### TECHNICAL FIELD

The present disclosure relates generally to providing and administering skill-based wagering games.

### BACKGROUND

Wagering games historically did not involve a skill-based component. Previously, wagering games included bonus games that involved a random chance event. The current solutions for skill-based game machines require complex user interactions that take away from the user experience.

### BRIEF SUMMARY OF THE DISCLOSURE

The present systems and methods relate generally to providing and administering skill-based wagering games.

In various embodiments, the present disclosure provides systems and methods for providing and administering wagering games. The present systems and methods can include processes for generating an outcome of a wagering game, for rendering an outcome of the wagering game, for processing inputs responsive to outcome of the wagering game, and for processing and performing actions responsive to the inputs. By the present systems and methods, a patron can be provided with a rendered display of wagering game outcome, and the rendered display may include a plurality of indicia in which a subset of the plurality of indicia is positioned along a pay line. Also, the present systems and methods can provide a user interface that includes a rendered display of a second plurality of indicia including a second subset of indicia based on the first subset. In addition, the present systems and methods can receive a selection of the second plurality of indicia and, in response to the selection, render a user interface including a matching of the second subset of indicia.

The systems and processes describe herein can generate and control wagering games, patron skill challenges, indicia matching game features, bonus games, and other interactive amusement and/or betting experiences.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 shows a network environment in which the present gaming system and gaming device(s) may operate, according to various embodiments of the present disclosure;

FIG. 2 shows an exemplary gaming device and user interface, according to various embodiments of the present disclosure;

FIG. 3 shows an exemplary gaming device and user interface, according to various embodiments of the present disclosure;

FIG. 4 shows an exemplary gaming device and user interface, according to various embodiments of the present disclosure;

FIG. 5 is a flowchart of certain functionality implemented by portions of game application executed in a gaming device in the networked environment of FIG. 1 according to various embodiments of the present disclosure;

FIG. 6 shows an exemplary gaming device and user interface, according to various embodiments of the present disclosure;

FIG. 7 shows an exemplary gaming device and user interface, according to various embodiments of the present disclosure;

FIG. 8 shows an exemplary gaming device and user interface, according to various embodiments of the present disclosure; and

FIG. 9 is a schematic block diagram that illustrates an example computing environment employed in the network environment of FIG. 1 according to various embodiments of the present disclosure.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

In the following paragraphs, the embodiments are described in further detail by way of example with reference to the attached drawings. In the description, well known components, methods, and/or processing techniques are omitted or briefly described so as not to obscure the embodiments. As used herein, the “present disclosure” refers to any one of the embodiments described herein and any equivalents. Furthermore, reference to various feature(s) of the “present embodiment” is not to suggest that all embodiments must include the referenced feature(s).

Among embodiments, some aspects of the present disclosure are implemented by a computer program executed by one or more processors, as described and illustrated. As would be apparent to one having ordinary skill in the art, one or more embodiments may be implemented, at least in part, by computer-readable instructions in various forms, and the present disclosure is not intended to be limiting to a particular set or sequence of instructions executed by the processor.

The embodiments described herein are not limited in application to the details set forth in the following description or illustrated in the drawings. The disclosed subject matter is capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. As used herein, the terms “machine,” “computer,” “server,” and “work station” are not limited to a device with a single processor, but may encompass multiple devices (e.g., computers) linked in a system, devices with multiple processors, special purpose devices, devices with various peripherals and input and output devices, software acting as a computer or server, and combinations of the above.

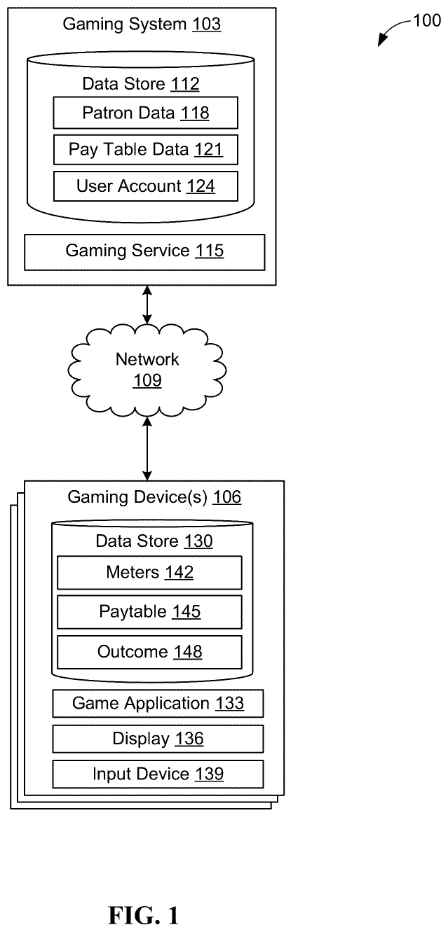

The present disclosure relates generally to providing and administering wagering games. Turning now to the drawings, exemplary embodiments are described in detail. With reference to FIG. 1, shown is a gaming environment system 100 according to various embodiments of the present disclosure. The gaming environment 100 includes a gaming system 103 and one or more gaming devices 106, which are in data communication with each other via a network 109. In some embodiments, the gaming environment 100 may include only one gaming device 106 as can be appreciated by one of skill in the art. The gaming device 106 can provide an outcome for a next play of a wagering game prior to a patron initiating a wager on the gaming device 106. The outcome can correspond to a payout (or award) from a pay table based on an achievable arrangement of indicia in the wagering game.

The wagering game can be generated and controlled by the gaming system 103, gaming device 106, or combinations thereof. The gaming device 106 can generate an outcome of the wagering game comprising a set of indicia. The gaming device 106 can determine that a particular combination of indicia of the set of indicia are positioned along a pay line or in a predetermined position. In response, the gaming device 106 can render a second set of indicia comprising at least two indicia corresponding to one indicium in the particular combination of indicia from the first set of indicia. In some embodiments, the at least two indicia correspond to two or more different indicia. The gaming device 106 can receive a selection of one indicium of the second set of indicia. In response to the particular indicium being one of the at least two indicia, the gaming device 106 can render a user interface indicating a matching of the at least two indicia and award a wagering game prize.

The game system 103 and gaming device 106 can generate and configure a matching-based wagering game such that a winning match of two or more indicia may be determined in response to a single input (e.g., a selection of a single indicium). The matching-based wagering game can include an indicia matching game feature. The gaming device 106 can generate a wagering game interface comprising a set of indicia. The gaming device 106 can generate the set of indicia such that the set of indicia includes at least one set of matching indicia. The gaming device 106 can receive an input to the wagering game interface (e.g., a patron selecting a region of a touch display, pressing a button, etc.). The gaming device 106 can determine a selection of a particular indicia of the set of indicia based on the input. The gaming device 106 can determine that the particular indicium is one of the indicia of the at least one set of matching indicia. In response to determining that the particular indicium is one of the indicia of the at least one set of matching indicia, the gaming device 106 can render a second wagering game interface comprising the at least one set of matching indicia. The gaming device 106 can also provide a wagering game prize based on the at least one set of matching indicia and potentially other factors, such as other particular indicia in the set of indicia.

The gaming device 106 can render additional visual elements on wagering game interfaces. For example, the gaming device 106 can render animations of spinning slot machine reels. The gaming device 106 can generate indicia comprising a visual appearance that corresponds to the visual element(s). For example, the gaming device 106 can generate a wagering game outcome including one or more indicia with a visual appearance that corresponds to one or more symbols of an animated slot machine reel.

The wagering game can include one or more indicia matching game features and/or bonus games. The indicia matching game feature or bonus game can be a skill game, such as, for example, an indicia matching game. In some embodiments, the wagering game can include a skill-based indicia matching game feature in addition to a skill-based indicia matching bonus game. The bonus game can include indicia from the corresponding wagering game from which the bonus game was awarded. For example, a wagering game outcome can include a first indicia, a second indicia, and a third indicia positioned along a pay line. A bonus game can include a skill-based indicia matching game including the first indicia and the second indicia, and potentially additional indicia.

The network 109 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

The gaming system 103 can include, for example, a point of sale “POS” system, a server computer, or any other system providing computing capability. Alternatively, the gaming system 103 may employ a plurality of computing devices that may be arranged, for example, in one or more server banks or computer banks or other arrangements. Such computing devices can be located in a single installation or may be distributed among many different geographical locations. For example, the gaming system 103 can include a plurality of computing devices that together may include a hosted computing resource, a grid computing resource, and/or any other distributed computing arrangement. In some cases, the gaming system 103 can correspond to an elastic computing resource where the allotted capacity of processing, network, storage, or other computing-related resources may vary over time.

Various applications and/or other functionality may be executed in the gaming system 103 according to various embodiments. Also, various data is stored in a data store 112 that is accessible to the gaming system 103. The data store 112 can be representative of a plurality of data stores 112 as can be appreciated. The data stored in the data store 112, for example, is associated with the operation of the various applications and/or functional entities described below.

The components executed on the gaming system 103, for example, include a gaming service 115, and other applications, services, processes, systems, engines, or functionality not discussed in detail herein. The gaming service 115 can be executed to monitor game play on the one or more gaming devices 106 and facilitate additional features on the gaming devices 106. As an example, the gaming service 115 can facilitate conferring awards to a patron, among other features.

The data stored in the data store 112 includes, for example, patron data 118 and pay table data 121, and potentially other data. The patron data 118 can include user account 124, and potentially other data. The patron data 118 can include historical wagering game outcomes and/or wagering game inputs, subsets of which can be associated with particular user accounts 124. The user account 124 can include authentication credentials, a user identifier, contact information, user preferences, or other identifying information. The user identifier can correspond to or include an identifier stored in a magnetic strip of a patron tracking card. In some embodiments, the patron data 118 can correspond to an anonymous patron. As an example, a gaming session of an anonymous patron can be tracked as credits, hand counts, games played, tickets, or other trackable aspects that are moved among gaming devices 106. The pay table data 121 can include, but is not limited to, one or more data objects relating awards (e.g., an indicia matching game feature, bonus games, award amounts, or derivatives thereof) to one or more wagering game outcomes and/or other wagering game parameters. For example, the pay table data 121 can include one or more tables that relate award values to one or more wagering game outcomes (e.g., such as various winning outcomes). The pay table data 121 can include combinations of indicia and respective awards associated therewith. The pay table data 121 can include, for example, one or more particular combinations of indicia that, when generated as an outcome of a wagering game, result in the gaming service 115 or game application 133 awarding an indicia matching game feature or a bonus game to the corresponding gaming device 106. In some embodiments, the pay table data 121 includes a formula or algorithm to generate award values for each indicia combination per outcome of a wagering game. The pay table data 121 can include seed values or other initializing information for the algorithms.

The gaming device 106 is representative of a plurality of gaming devices that may be coupled to the network 109. The gaming device 106 can include a data store 130, a game application 133, one or more displays 136, and one or more input devices 139, among other components. The data store 130 can include, but is not limited to, meters 142, one or more pay tables 145, and one or more outcomes 148.

The meters 142 can include, for example, a number of games played on the gaming device 106, a hand count (e.g., a count of games initiated at one or more particular gaming devices 106 or on behalf of one or more particular patrons), a predetermined play interval (e.g., 1 minute, 30 minutes, 1 hour, or any suitable period), and potentially other values. The meters 142 can further include, but are not limited to, an amount of money deposited into the gaming device 106 referred to as coin-in, an amount paid by the gaming device 106 referred to as coin-out, and various jackpot, bonus, and ticketing information, among other meters.

The game application 133 or gaming service 115 can provide an award to the gaming device 106, or an associated patron, in response to a meter 142 exceeding a predetermined threshold. For example, the game application 133 can increment a meter 142 in response to a patron initiating a wagering game at a gaming device 106 (e.g., or in response to generating an outcome of the wagering game). The game application 133 can determine that the current value of a meter 142 (e.g., the value following increment) meets a predetermined threshold. In response to the meter 142 meeting the predetermined threshold, the game application 133 can award an indicia matching game feature or a bonus game to the corresponding gaming device 106.

The one or more pay tables 145 can include one or more data objects (e.g., tables, etc.) that relate pay table data 121 (e.g., retrieved from the data store 112) to the one or more outcomes 148. The pay table 145 can be stated or unstated to the patron. For example, the game application 133 can render the pay table 145 on the display 136. The pay table 145 can include, for example, one or more combinations of indicia that, when present in the outcome of a wagering game, result in the game application 133 or gaming service 115 awarding an indicia matching game feature or a bonus game to the gaming device 106 with which the outcome is associated, another gaming device 106, or a user account 124. The one or more pay tables 145 may be unstated, such as by excluding the pay table 145 from all renderings produced on a display 136 and may be programmatically inaccessible to a patron (e.g., via an input device 139). Any of the data stored in the pay table data 121 may be stored in pay table 145 instead of or in addition to pay table data 121.

The one or more outcomes 148 can include, but are not limited to, one or more generated wagering game outcomes, historically generated wagering game outcomes, and all outcome 148 permutations for one or more combinations of indicia. In at least one embodiment, the gaming device 106, or gaming system 103, may iteratively update the data store 130 to include newly generated outcomes 148, update one or more pay tables 145, and/or adjust associations between outcomes 148 and pay table data 121. For example, the gaming service 115 can update pay table data 121 that an indicia matching game feature or a bonus game award is dissociated from a first combination of indicia and associated with a second combination of indicia. The game application 133 can update the pay table 145 based on the updated pay table data 121. The gaming service 115, or game application 133, can reconfigure outcome generation processes such that subsequent wagering game outcomes include the second combination of indicia.

The gaming device 106 can include, for example, an amusement device, a slot machine, or other gaming device with a processor-based system such as a computer system. Such a computer system may be embodied in the form of a computing device in a slot machine cabinet, a desktop computer, a laptop computer, personal digital assistants, cellular telephones, smartphones, set-top boxes, music players, web pads, tablet computer systems, game consoles, electronic book readers, or other devices with like capability. The gaming device 106 can include a display 136. The display 136 can include, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The input device 139 can include one or more buttons, touch screens (including three-dimensional or pressure-based touch screens), cameras, fingerprint scanners, accelerometers, retinal scanners, gyroscopes, magnetometers, or other input devices. The input device 139 can also include a bill acceptor, a player tracking module, a ticket printer, or other devices.

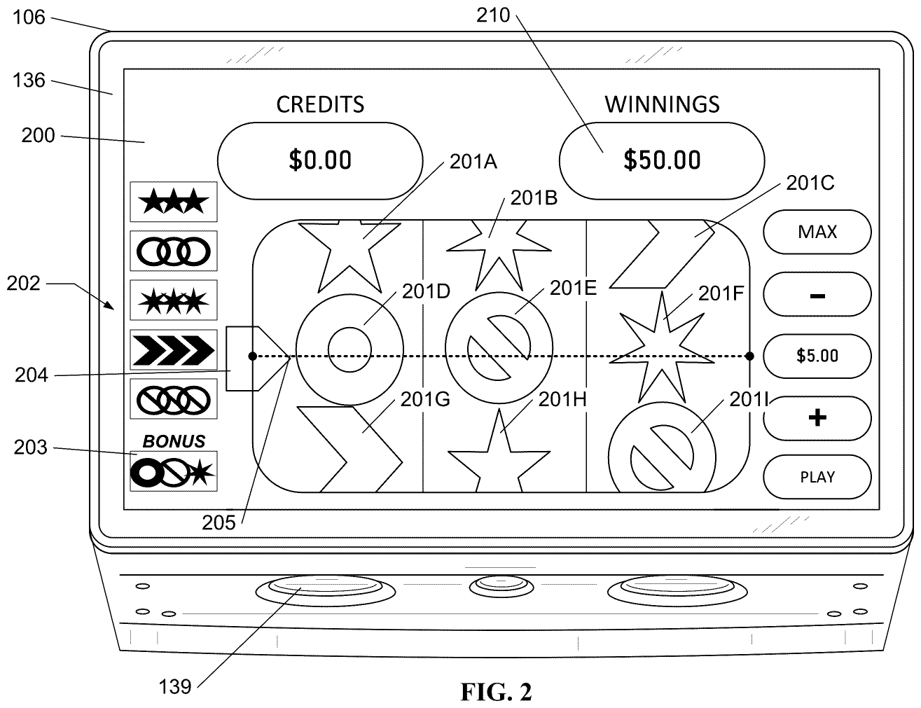

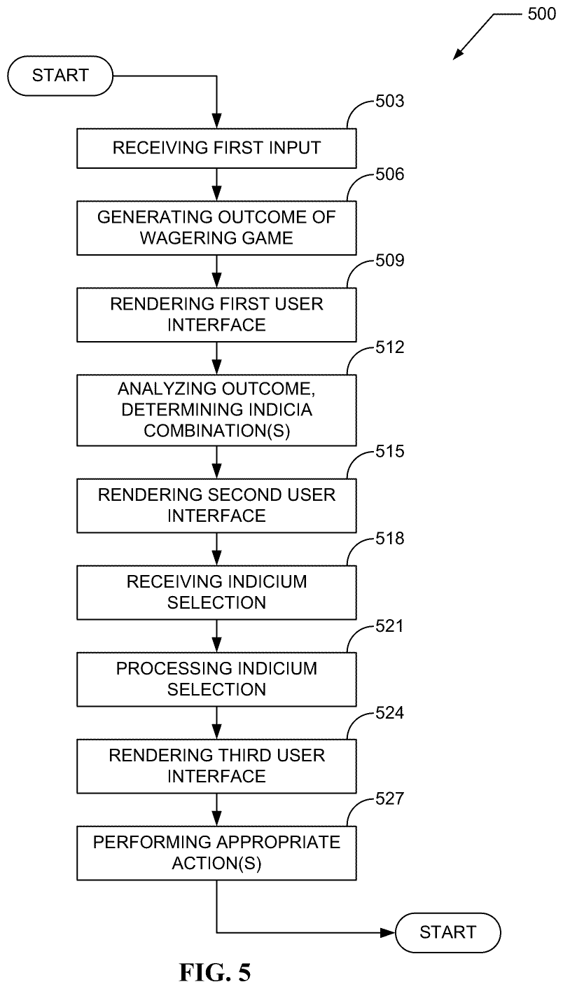

The gaming device 106 can be configured to execute various applications, such as the game application 133 and/or other applications. The game application 133 may be executed in a gaming device 106, for example, to access network content served up by the gaming system 103, and/or other servers, thereby rendering various user interfaces on the display 136. The game application 133 can perform actions and processes described herein, such as the process 500 shown in FIG. 5. The game application 133 can generate user interfaces, such as the user interfaces 200, 300, 400, 600, 700, and 800 shown in FIGS. 2, 3, 4, 6, 7, and 8, respectively. In some embodiments, the game application 133 can include, for example, a browser, a dedicated application, etc., and the user interface can be a network page, an application screen, etc. The gaming device 106 can be configured to execute applications beyond the gaming application 133 such as, for example, a patron tracking service window application, email applications, social networking applications, word processors, spreadsheets, and/or other applications. In certain embodiments, one or more processes and functions described as being performed or taken by the game application 133 may instead be performed by the gaming service 115, or vice versa.

The game application 133 can generate wagering game outcomes, such as a particular combination of indicia from a plurality of indicia. The game application 133 can generate user interfaces for displaying wagering game information, gameplay, and outcomes. The game application 133 can render the user interface on the display 136. The game application 133 can analyze the position of indicia based on a wagering game outcome (e.g., and/or based on the position of indicia on a user interface). For example, the game application 133 can determine that a particular combination of indicia is positioned along a pay line, which may be stated or unstated on the user interface. The game application 133 can perform additional actions based on the outcome of wagering games, such as initiating an additional wagering game, initiating an indicia matching game feature, or initiating a bonus game.

In an exemplary scenario, the game application 133 initiates a wagering game including generating a wagering game outcome and, based on thereon, rendering a user interface including a pay line and a plurality of indicia at various positions on a plurality of reels. The game application 133 determines that a particular combination of indicia is positioned along the pay line. In response to the determination, the game application 133 awards an indicia matching game feature or a bonus game including rendering a second plurality of indicia that includes a subset of the particular combination of indicia. The game application 133 receives a selection of a particular indicia of the second plurality of indicia. The game application 133 determines that the particular indicia is one of the indicia from the subset of the particular combination of indicia. In response to the determination, the game application 133 awards a matching bonus and renders a new user interface, or updates the current user interface, to display a matching of the subset of the particular indicia.

In various embodiments, a gaming session can start with an insertion of credits (e.g., coin-in) onto a game, with the authentication of a user account, or when some other trigger occurs. A gaming session can terminate when a patron cashes out a machine, when a patron logs out of the gaming devices, or some other trigger occurs.

Next, a general description of the operation of the various components of the gaming environment 100 is provided. To begin, a game application 133 can generate an outcome 148 of a wagering game. The term “wagering game” can include non-monetary wagering games or other amusement games, such as social games where virtual currency is wagered or skill-based games that involve wagering. The outcome 148 can include a plurality of indicia, and each indicia or symbol may be located at a particular position, such as along one or more pay lines. The game application 133 can intentionally generate an outcome 148 that include no winning pay lines, but where a single change to one of the indicia would result in a winning combination along a pay line. The game application 133 can identify the indicia that would result in the winning combination along a pay line from the generated outcome such that an award value would be paid.

The game application 133 can store the identified indicia (e.g., and/or other data directing thereto), the value of the award corresponding to the winning combination, and the position of the indicia in a data store 130. The game application 133 can render the value of the award on a display 136, thereby advertising a prize that may be won by a patron in the next wagering game initiated at the gaming device 106. The award can be rendered on the display prior to receiving any wager for the wagering game corresponding to the generated outcome from a patron. A patron can use existing credits on the gaming device 106 or add credits to the gaming device 106, such as, for example, by inserting money or a ticket into a bill accepter or coin accepter of the gaming device 106 or by performing a cashless transfer to the gaming device 106. The game application 133 can process the added credits to add coin-in to a coin-in meter 142. In some embodiments, the patron may pay an amount of currency to an attendant to add credit corresponding to the amount to a particular gaming device 106. The attendant can enter the credit into the gaming service 115, and the gaming service 115 can send a message to the game application 133 to add coin-in to the gaming device 106.

The gaming device 106 can receive, via an input device 139, an indication to initiate the wagering game (e.g., for which the game application 133 generated the outcome 148). As an example, the patron can press a button to initiate the wagering game. The game application 133 can render, on the display 136, the value of the award corresponding to generated outcome 148 of the wagering game. The generated outcome 148 can include positioning information for plurality of indicia, each oriented at their particular position as set forth in the positioning information. The positioning information can include a position of a reel strip for each column or row of the wagering game.

The gaming device 106 can receive, via an input device 139, a selection of an indicia. The game application 133 can process the selection and determine if the selected indicia match the identified indicia. The game application 133 can change the selected indicia to a “wild” indicia or to a specific indicia that would result in a pay line that achieves a winning outcome. If the selected indicia match the identified indicia, selected indicia will cause the identified winning outcome to occur, and the game application 133 can provide the award to the patron, such as by initiating an indicia matching game feature or a bonus game at the gaming device 106. In at least one embodiment, following conclusion of the first initiated wagering game, the game application 133 can automatically generate an outcome and identify an indicia associated with a subsequent (e.g., to-be-played) wagering game. As an example, after a then current wagering game is initiated but before a subsequent wagering game is initiated, the gaming application 133 can generate an outcome 148 of the subsequent wagering game. Upon completion of the current wagering game, the game application 133 can render the achievable award value for the subsequent wagering game on the display.

The patron can initiate a cash out of the wagering game. The game application 133 can determine a payout of the wagering game. The payout can correspond to a value of the current credits on the game. In some embodiments, when a cash out occurs, the game application 133 can print a ticket. In one example, the gaming service 115 can send an identifier to be printed on the ticket. In another example, the game application 133 can determine a next sequential ticket number using a predetermined algorithm. When a patron redeems the ticket at another gaming device 106, the game application 133 can send the identifier read from the ticket to the gaming service 115. The game application 133 can send a value of coin-out meter, coin-in meter, various other meters, bonus information, and other wagering game information. The gaming service 115 can send various information including awards and bonuses to the game application 133.

With reference to FIG. 2, shown is an example user interface 200 rendered on a display 136 of a gaming device 106, according to various embodiments of the present disclosure. The game application 133 or gaming service 115 can generate and render the user interface 200 on the display 136.

The user interface 200 can correspond to an outcome of a wagering game initiated at the gaming device 106. The user interface can include a plurality of indicia 201A-I. The plurality of indicia 201A-I can be arranged along a plurality of reels. The user interface 200 can include a pay table 202 that indicates various combinations of indicia 201A-I and corresponding awards that may be obtained in response to an outcome of a wagering game including a particular combination of indicia 201A-I. The pay table 202 can include a bonus 203 that indicates a particular combination associated with an indicia matching game feature or a bonus game (e.g., in response to an outcome of the wagering game being the particular combination of bonus 203, the game application 133 awards an indicia matching game feature or a bonus game). For example, the bonus 203 shown in FIG. 2 denotes that a bonus game may be obtained via an outcome that includes a donut indicium, a prohibition indicium, and a seven-pointed star indicium.

The user interface 200 can include a pay line indicator 204 that provides a visual indication of a particular combination of indicia that correspond to the outcome of the wagering game. The user interface 200 can include one or more pay lines 205 for visually denoting indicia corresponding to one or more outcomes of the wagering game. As used herein, a pay line can refer to the series of positions occupied by indicia in the wagering game visually represented by the pay line 205.

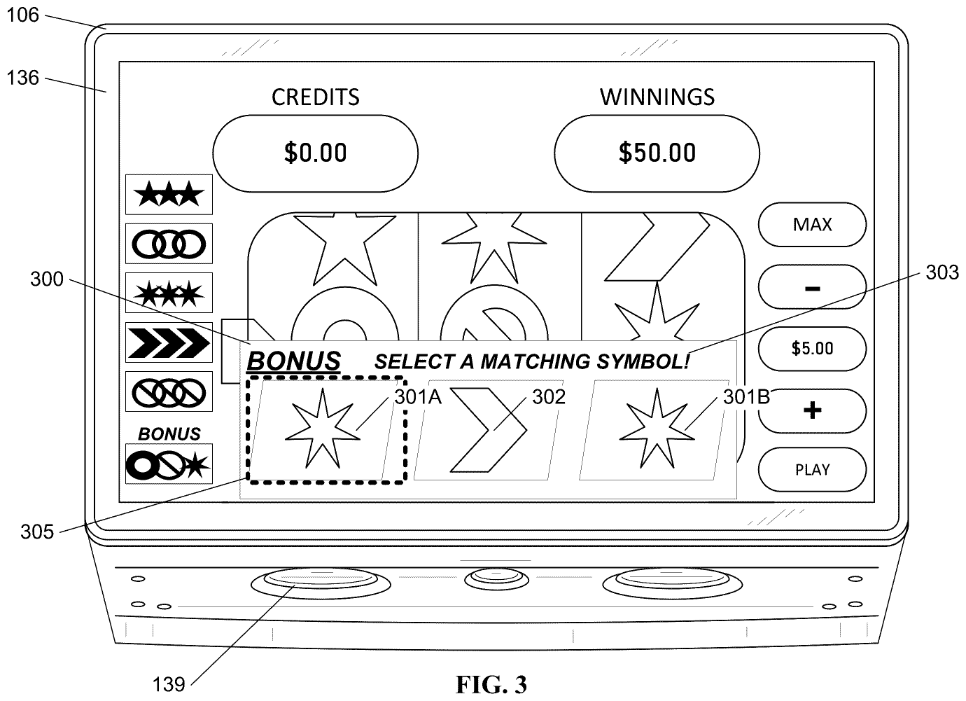

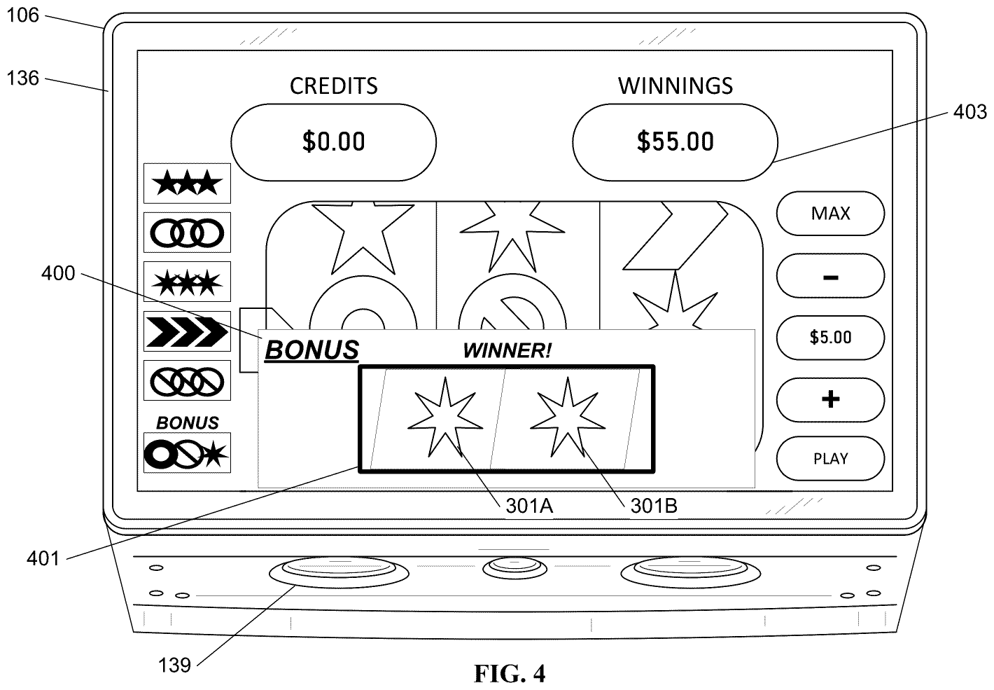

As shown in FIG. 2, the user interface 200 includes a particular combination of indicia positioned along the pay line, the particular combination including indicium 201D (e.g., a donut indicium), indicium 201E (e.g., a prohibition indicium), and indicium 201F (e.g., a seven-pointed star indicium). The game application 133 (not shown) can determine that the particular combination of indicia 201D, E, F corresponds to the bonus 203. In response, the game application 133 can award a corresponding bonus to the gaming device 106. For example, as further illustrated in user interfaces 300 and 400 shown in FIGS. 3 and 4, respectively, the game application 133 can award and initiate an indicia matching game feature or a bonus game. In some embodiments, the bonus game, as described herein and illustrated in FIGS. 3-5, is instead an indicia matching game feature of a wagering game.

With reference to FIG. 3, shown is an example user interface 300 rendered on a display 136 of a gaming device 106, according to various embodiments of the present disclosure. The game application 133 can generate and render on the user interface 300. The user interface 300 can include two or more indicia that correspond to one or more of the indicia from the outcome of a wagering game. For example, the user interface 300 includes indicium 301A, 301B that correspond to indicium 201F (FIG. 2) and an additional indicium 302 that may or may not correspond to an indicia of the particular combination of indicia from the wagering game. As another example, while not shown in FIG. 3, the user interface 300 can include two or more indicia identical to, or otherwise corresponding to, the indicium 201D or the indicium 201E (FIG. 2).

The user interface 300 can include an instruction 303, such as, for example an instruction to “select a matching symbol.” The instruction 303 can prompt a patron to provide a selection of a particular indicium in the user interface 300 for which there is a duplicate or otherwise corresponding second indicium.

The game application 133 can receive a selection of a particular indicium in the user interface 300 via an input to the input device 139. The selection can be indicated on the user interface 300, such as by the game application 133 rendering a selection indicator 305 at a position corresponding to the selected indicium. As shown in FIG. 3, the gaming device 106 can receive a selection for the indicium 301A. The game application 133 can process the selection and, based thereon, render the selection indicator 305 at a position corresponding to the indicium 301A.

With reference to FIG. 4, shown is an example user interface 400 rendered on a display 136 of a gaming device 106, according to various embodiments of the present disclosure. The game application 133 can process a selection of a particular indicia and determine that the particular indicia is one of the two or more indicia of the particular combination from the outcome of the wagering game (e.g., and that were included as indicia, or used as a basis for generating corresponding indicia, in the indicia matching game feature or bonus game initiated in response to the outcome).

In response to the selected indicia being one of the two or more indicia from the particular combination of indicia, the game application can render the user interface 400 including a matching indicator 401 of the two or more indicia. The game application 133 can also award a matching bonus corresponding to the matching of the two or more indicia.

For example, in response to receiving a selection of the indicia 301A (FIG. 3), the game application 133 can determine that the indicia 301A corresponds to the indicia 201F (FIG. 2). In response to the determination, the game application 133 can render, on the user interface 400, a matching indicator 401 that indicates a matching of the indicia 301A and indicia 301B. The game application 133 can also provide a matching bonus by updating a meter 142 (not shown). The game application 133 can indicate the matching bonus by rendering, or updating a rendering of, a winnings indicator 403. Additional description of wagering game processes and aspects shown in FIGS. 2-4 and described herein are provided in the proceeding description of FIG. 5 and process 500 depicted thereby.

Before turning to the process flow diagrams of FIG. 5, it is noted that embodiments described herein may be practiced using an alternative order of the steps illustrated in FIG. 5. That is, the process flows illustrated in FIG. 5 are provided as examples only, and the embodiments may be practiced using process flows that differ from those illustrated. Additionally, it is noted that not all steps are required in every embodiment. In other words, one or more of the steps may be omitted or replaced, without departing from the spirit and scope of the embodiments. Further, steps may be performed in different orders, in parallel with one another, or omitted entirely, and/or certain additional steps may be performed without departing from the scope of the embodiments.

With reference to FIG. 5, shown is a flow chart of a process 500 according to various embodiments of the present disclosure. The gaming system 103 and/or the gaming device 106 (e.g., shown in FIG. 1 and described herein) can perform the process 500, or one or more steps thereof.

At box 503, the process 500 includes receiving a first input, such as an input for initiating a wagering game at a gaming device 106. The first input can include, for example, an amount of coin-in or other credit and a selection for initiating the wagering game. The first input can be one or a plurality of inputs to a gaming device 106 or a system in communication with the gaming device 106 (e.g., the gaming system 103, a patron's computing device, or an external system). The gaming device 106 can receive the first input via one or more input devices 139. The first input can include a request to initiate a wagering game at the gaming device 106, an amount of coin-in or other cost of initiating the wagering game, and potentially other data. The first input can include a patron identifier and/or other information by which a patron data 118 corresponding to a particular patron may be identified and/or authenticated. The first input can include a ticket or other scannable media from which coin-in, wagering game credits, accrued winnings, and/or patron identifier may be obtained. The first input can include credentials, such as, for example, a username and/or password or biometric data for authenticating the patron. The first input can include a selection for a particular type of wagering game to be initiated from a gaming library or other repository of various types of wagering games. The first input can include a wager amount, which may be a coin-in amount, an amount of wagering game credits associated with the patron (e.g., or patron data 118 associated therewith), or an amount of currency separate from the coin-in amount. In one example, the wager amount includes an amount of coin-in corresponding to a predetermined maximum wager amount. In some embodiments, the gaming device 106, or gaming system 103, performs steps 506-527 of the process 500 in response to the input including an amount of coin-in, or other wager amount, which meets a predetermined threshold, such as a maximum wager amount.

At box 506, the process 500 includes generating an outcome of the wagering game, referenced herein and in FIG. 1 as the outcome 148. The game application 133 can generate an outcome 148 by determining, prior to or following a wager being placed, a respective position of each of a plurality of indicia. The outcome 148 can be the plurality of indicia, with each indicium arranged according to their respective position. The outcome 148 can correspond to a position of a reel of indicia in each column or row of the wagering game (see, for example, the user interface 200 shown in FIG. 2 and described herein).

The game application 133 can generate an outcome 148 that includes a particular combination of indicia, such as, for example, a combination of indicia associated with initiating an indicia matching game feature or a bonus game. For example, the game application 133 generates an outcome 148 including a particular combination of indicia corresponding to a bonus 203 as shown in FIG. 2 and described herein. To generate the particular combination, the game application 133 can process one or more outcome generation rules or algorithms that cause outcome generation processes to exclude outcomes that would not result in the gaming device 106 awarding an indicia matching game feature or a bonus game. The game application 133 may also utilize pay table data 121 and/or one or more pay tables 145 as an input to outcome generation processes (e.g., for purposes of generating particular combinations, such as bonus-triggering combinations). In one embodiment, the game application 133 may iteratively generate trial outcomes until an outcome is generated where no winning combination is achieved. In another embodiment, the gaming application 133 can generate a winning combination and modify the winning combination to a second winning combination that results in the awarding of an indicia matching game feature or a bonus game. In some embodiments, the processes and functions herein ascribed as being performed to provide a bonus game are instead performed to provide an indicia matching game feature of a wagering game.

In one embodiment, two or more indicia may be substantially similar if the indicia include the same symbols or graphical elements. The substantially similar indicia may differ because of one or more animations of the indicia. For example, a pear may be moving up and down for one indicium while stationary in another. As another example, the animation may be time-sequenced across two or more indicia or different animations may be applied to different indicia.

At box 509, the process 500 includes rendering a first user interface on the display 108 of the gaming device 106. The game application 133 can render the first user interface based on the outcome 148 generated at box 506. The first user interface can include the outcome 148. For example, the first user interface includes a plurality of indicia positioned across three reels and a subset of the plurality of indicia positioned along a pay line. The first user interface can include a rendering of a pay table 145, such as an indication of potential outcomes 148 and corresponding awards. In one example, the first user interface includes a visual indication of a combination of indicia associated with an indicia matching game feature or a bonus game award. The game application 133 can animate the first user interface, such as by rotating a plurality of reels from a first position to a second position associated with the outcome 148.

At box 512, the process 500 includes processing the outcome of the wagering game. The game application 133 can process the outcome 148, such as by determining that the outcome 148 includes of one or more particular combinations of indicia. Based on the outcome 148, the game application 133 can determine that a particular combination of indicia is positioned along a pay line. The game application 133 can process additional data, such as inputs that adjust (e.g., “nudge”) the position of one or more indicia, or reels including the same. The game application 133 can process the outcome 148 and pay table data 121 corresponding to the wagering game initiated. The game application 133 can determine that the outcome 148 is associated with a particular award, such as an indicia matching game feature, a bonus game, or an amount of award credit. The game application 133 can provide the award to the gaming device 106 or a user account 124 corresponding to the patron that initiated the wagering game.

At box 515, the process 500 includes rendering a second user interface at the gaming device 106. The game application 133 can render, on the display 136, a second user interface. The game application 133 can generate the second user interface based on the outcome 148 of box 506, or one or more determinations that were generated based thereon. The game application 133 can generate and render the second user interface in response to the outcome 148 being associated with a particular award, such as an indicia matching game feature or a bonus game. The game application 133 initiate the indicia matching game feature or the bonus game by generating and rendering the second user interface. The game application 133 can include one or more indicia from the first user interface in the second user interface (e.g., the game application may reuse one or more indicia from the wagering game in the indicia matching game feature or the bonus game). For example, the first user interface can include a plurality of indicia including a particular combination of indicia positioned along a pay line. The game application 133 can generate a second user interface including two or more indicia identical to, or otherwise corresponding to, one or more indicia of the particular combination of indicia. The game application 133 can generate the second user interface based on a combination of indicia positioned at particular positions of one or more reels. The game application 133 can generate the second user interface based on a combination of indicia that are not positioned along a pay line. The second user interface can include a subset of indicia from the combination of indicia positioned along the pay line (e.g., or other indicia combinations associated with the outcome of the wagering game).

In one example, a particular combination of indicia is positioned along a pay line. The particular combination of indicia can include a first indicium, a second indicium, and the third indicium. The game application 133 can generate and render on the display 136 a second user interface that includes the first indicium and the second indicium (e.g., or the first indicium and the third indicium, or the second indicium and the third indicium).

At box 518, the process 500 includes receiving a selection of an indicium from the second user interface. The gaming device 106 can receive, via the input device 139, a selection of particular indicia of the plurality of indicia rendered on the second user interface. For example, the gaming device 106 receives an input to a particular region of a touch-screen display that corresponds to a particular indicium. The game application 133 can generate and render on the second user interface a pre-selection of a particular indicia. The game application 133 can receive an input for confirming the pre-selection, thereby selecting the particular indicium.

In one example, the second user interface includes a first set of indicia, a second set of indicia identical to the first indicia, and a third set of indicia different from the first indicia. The game application 133 can generate and render a pre-selection of the first indicia or the second indicia, such as by rendering a shape that outlines the first indicia or the second indicia. The game application 133 can receive an input via the input device 139 that confirms the pre-selection. In response to the input, the game application 133 can determine that the patron selected the indicium corresponding to the rendered pre-selection.

At box 521, the process 500 includes processing the indicia selection of box 518. The game application 133 can determine a rendered indicium that corresponds to the selection input. The game application 133 can determine whether the selected indicium matches another indicium of the second user interface (e.g. or updated first user interface). The game application 133 can determine that the selected indicium is one of the two or more indicia rendered on the second user interface based on the particular combination of indicia corresponding to the outcome of the wagering game.

For example, the second user interface can include a first indicium, a second indicium identical to the first indicium, and a third indicium different from the first indicium. The game application 133 can receive a selection of the first indicium, process the selection, and determine that the selected first indicium matches the second indicium (e.g., and vice versa for a scenario in which the second indicium is pre-selected and confirmed via user input).

The game application 133 can determine that the selected indicium is identical to, or otherwise corresponds to, an indicium of the two or more indicia that were rendered on the second user interface based on one or more indicia from the particular combination of indicia with which the outcome of the wagering game is associated.

For example, at boxes 506-509, the game application 133 can generate an outcome of a wagering game comprising a plurality of indicia and render a user interface comprising the plurality of indicia. At box 512, the game application 133 can determine that a particular combination of indicia of the plurality of indicia are positioned along a pay line. At box 515, the game application 133 can render a second user interface comprising a second plurality of indicia comprising at least two indicia corresponding to one indicium in the particular combination of indicia from the wagering game. At box 518, the game application 133 can receive and process a selection of a particular indicium of the second plurality of indicia. At box 521, the game application 133 can determine that the selected indicium is one of the at least two indicia corresponding to the one indicium in the particular combination of indicia from the wagering game.

The game application 133 can determine that an indicium selection corresponds to an indicium for which there is no matching second indicium in the second user interface. For example, the second user interface can include a first indicium, a second indicium identical to the first indicium, and a third indicium different from the first indicium. The game application 133 can process an input that selects the third indicium and determine that the selected indicium fails to match the first indicium and the second indicium.

At box 524, the process 500 includes rendering a third user interface based on the selection of the particular indicia (e.g., or processing thereof). The game application 133 can generate a third user interface or update the second user interface or first user interface. At box 521, the game application 133 can determine that the selected indicium is one of the at least two indicia corresponding to the one indicium in the particular combination of indicia from the wagering game. At box 524, in response to the determination, the game application can render, on the display 136, a user interface that indicates a matching of the at least two indicia.

Alternatively, the game application 133 can determine that the selected indicium is not one of the at least two indicia corresponding to the one indicium in the particular combination of indicia from the wagering game. In response to the determination, the game application 133 can render a user interface that indicates a mismatch between the selected indicium and the at least two indicia (e.g., of the second plurality of indicia rendered at box 515) that correspond to the particular combination of indicia from the wagering game.

At box 527, the process 500 includes performing one or more appropriate actions. The game application 133 can award a matching bonus to a user account 210 and/or the gaming device 106. The game application 133 may award the matching bonus, for example, in response to the selected indicium of box 518 being one of the at least two indicia corresponding to the one indicium in the particular combination of indicia from the wagering game. The matching bonus can include, for example, an amount of award credit, an amount of currency, a free wagering game, or other suitable prizes. The game application 133 can display the matching bonus on the display 136. The game application 133 can initiate a payout of the matching bonus (e.g., automatically or in response to receiving a user input for initiating payout). The game application 133 can increment one or more meters 142, such as a meter 142 for counting a quantity of matching bonuses awarded at the gaming device 106, awarded to a user account 210, awarded within a predetermined period (e.g., 1 hour, 1 day, 1 week, or any suitable period), combinations thereof, etc. The game application 133 can encode the matching bonus into scannable media (e.g., a bar code, QR code, or other identifier) and display and/o print the scannable media. The game application 133 can transmit an indication of the matching bonus (e.g., and potentially other data, such as a gaming device identifier or patron identifier) to the gaming service 115. The gaming service 115 can record the awarding of the matching bonus in patron data 118 corresponding to the gaming device 106 and/or a particular user account 124.

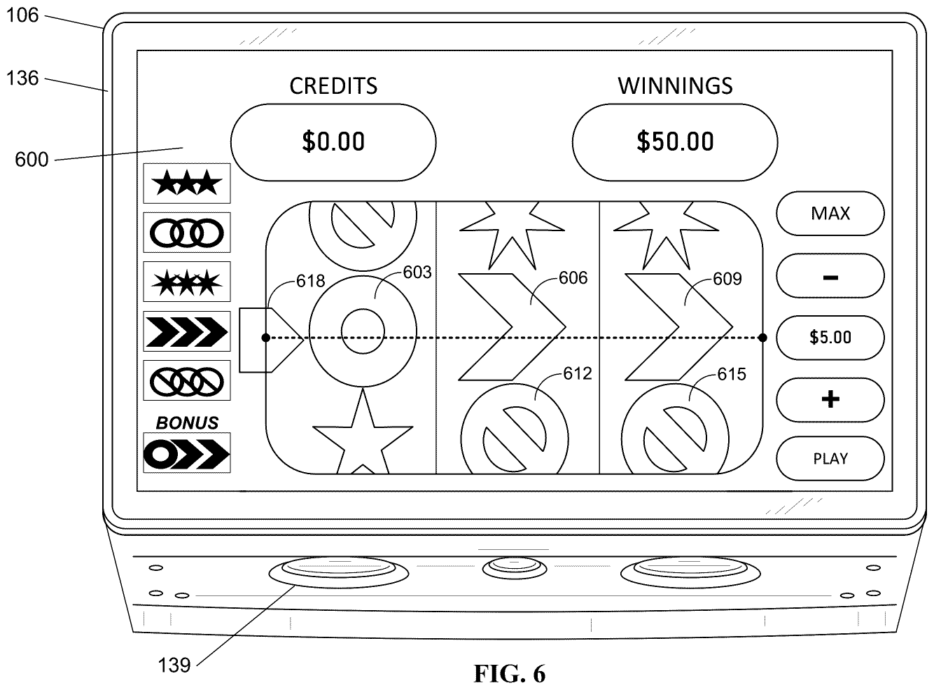

FIG. 6 shows a gaming device 106 and an exemplary user interface 600 that can be rendered on a display 136 of the gaming device 106, according to various embodiments of the present disclosure. The user interface 600 can include one or more indicia including indicia 603, 606, 609, 612, and 615. The user interface 600 shows exemplary matching indicia 606 and 609, matching indicia 612 and 615, and different indicia 603.

In one embodiment, the payline 618 can show a series of indicia (e.g., indicia 603, 606, and 609) that match a winning combination. The gaming device 106 can render a matching game on the display. The matching game can include indicating that one or more symbols are selectable. In one embodiment, the payline 618 is indicated by illuminating the indicia 603, 606, and 609. Indicia can be indicated by illuminating, rendering graphics around or next to an indicium, rendering graphics around or next to a set of indicia, such as indicia available for selecting in a matching games. The gaming device 106 can determine a match was successful when one of a matching set of indicia (e.g., indicia 606 or 609) is selected. The gaming device 106 can determine a match failed if an unmatched symbol is selected (e.g., indicium 603). In one embodiment, the game device 106 can award no credits for a winning combination of indicia on the payline 618 when an unmatched symbol is selected.

In one embodiment, a two select matching game is presented such that the gaming device 106 determines a match was successful when two or more of a matching set of indicia (e.g., indicia 606 and 609) are selected. In one embodiment, the gaming device 106 can generate a second matching game. The second matching game can be generated using the existing indicia on the board, such as indicia 612 and 615, or by using a new set of indicia, such as indicia 301A, 302, and 301B. In one embodiment, the second matching game is only available if the first matching game is unsuccessful. In another embodiment, the second matching game is only available if the first matching game is successful. In one embodiment, the first matching game can involve selecting two matching symbols, while the second matching game can involve selecting one matching symbol to generate the award. In some embodiments, the second matching game can award credits based on a bet amount when a winning symbol is selected.

For example, the second matching game can award the bet amount back to a patron when a match is successful. In one example, the gaming device 106 can: 1) determine wagering game results in a winning payline, 2) present the first matching game, 3) receive an invalid match input, 4) determine the patron earns no credits for the wagering game or the first matching game, 5) present a second matching game, 6) receive a successful matching input, and 7) award the patron a percentage of the bet amount for the wagering game for the second game. The percentage can be 96%, 100%, 104%, another percentage between 80-120%, or some other percentage. In some embodiments, the second matching game can facilitate the return of a bet amount back to the patron when they make an incorrect selection in the first matching game.

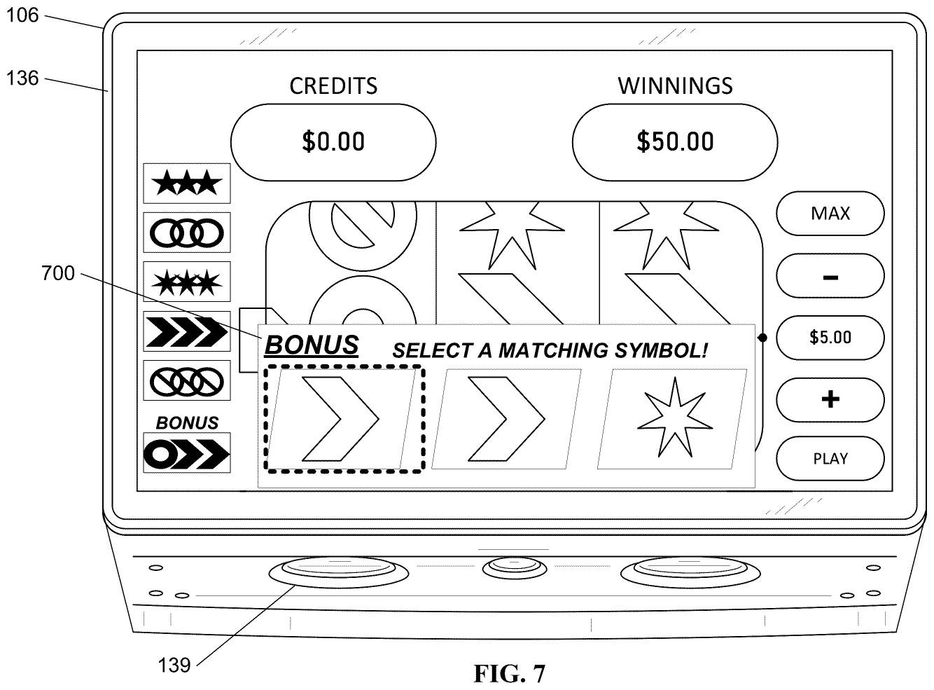

FIG. 7 shows a gaming device 106 and an exemplary user interface 700 that can be rendered on a display 136 of the gaming device 106, according to various embodiments of the present disclosure.

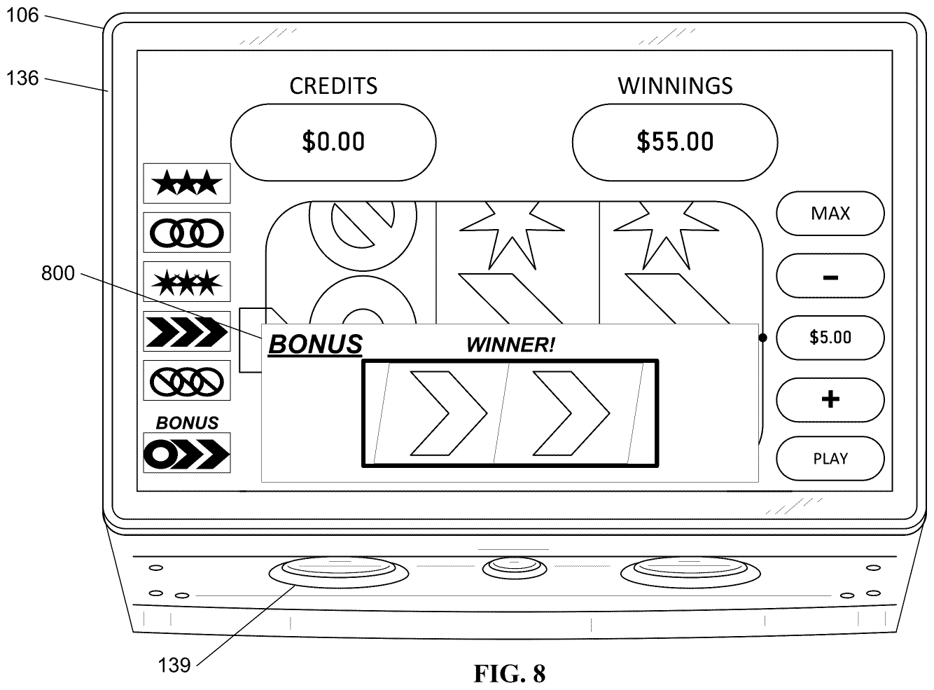

FIG. 8 shows a gaming device 106 and an exemplary user interface 800 that can be rendered on a display 136 of the gaming device 106, according to various embodiments of the present disclosure.

In various embodiments, the user interfaces 600, 700, 800 illustrate additional exemplary aspects of the present gaming systems, devices, and processes. For example, the user interfaces 600, 700, 800 demonstrate how the gaming application 133 (not shown, see FIG. 2), can perform various actions. For example, the user interfaces 600, 700, 800 demonstrate that the game application 133 can, in any suitable sequence, a) generate an outcome of a wagering game comprising a plurality of indicia user interface 600), b) determine that the outcome of the wagering game comprises a particular combination of indicia, c) in response to the particular combination of indicia, render a second plurality of indicia comprising at least two indicia corresponding to one indicium in the particular combination of indicia from the wagering game, d) receive a selection of one of the second plurality of indicia, and e) in response to the selection, render a user interface indicating a matching of the at least two indicia and award a matching bonus. In various embodiments, steps a-b) can correspond to the user interface 600, actions c-d) can correspond to the user interface 700, and action e) can correspond to the user interface 800.

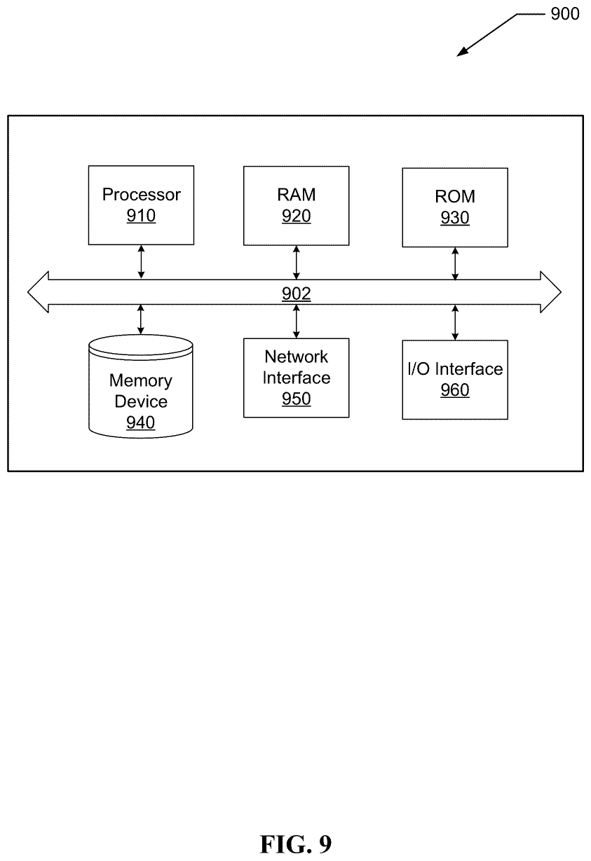

Turning to FIG. 9, an example hardware diagram of a computing device 900 is illustrated. Any of the gaming system 103 or the gaming devices 106 may be implemented, in part, using one or more elements of the computing device 900. The computing device 900 can include one or more of a processor 910, a Random Access Memory (“RAM”) 920, a Read Only Memory (“ROM”) 930, a memory device 940, a network interface 950, and an Input Output (“I/O”) interface 960. The elements of the computing device 900 are communicatively coupled via a bus 902.

The processor 910 can include an arithmetic processor, Application Specific Integrated Circuit (“ASIC”), or other types of hardware or software processors. The RAM 920 and ROM 930 can include a memory that stores computer-readable instructions to be executed by the processor 910. The memory device 940 stores computer-readable instructions thereon that, when executed by the processor 910, direct the processor 910 to execute various aspects of the present disclosure described herein. When the processor 910 includes an ASIC, the processes described herein may be executed by the ASIC according to an embedded circuitry design of the ASIC, by firmware of the ASIC, or both an embedded circuitry design and firmware of the ASIC. As a non-limiting example group, the memory device 940 comprises one or more of an optical disc, a magnetic disc, a semiconductor memory (i.e., a semiconductor, floating gate, or similar flash based memory), a magnetic tape memory, a removable memory, combinations thereof, or any other known memory means for storing computer-readable instructions. The network interface 950 can include hardware interfaces to communicate over data networks. The I/O interface 960 can include device input and output interfaces such as keyboard, pointing device, display, communication, and other interfaces. The bus 902 can electrically and communicatively couple the processor 910, the RAM 920, the ROM 930, the memory device 940, the network interface 950, and the I/O interface 960, so that data and instructions may be communicated among them.

In operation, the processor 910 is configured to retrieve computer-readable instructions stored on the memory device 940, the RAM 920, the ROM 930, or another storage means and copy the computer-readable instructions to the RAM 920 or the ROM 930 for execution, for example. The processor 910 is further configured to execute the computer-readable instructions to implement various aspects and features of the present disclosure. For example, the processor 910 may be adapted and configured to execute the processes described above with reference to FIGS. 2 and 3, including the processes described as being performed by the gaming system 103 or gaming devices 106. Also, the memory device 940 may store the data stored in the data store 112 or 130.

Clause 1. A system, comprising: a memory; and a computing device in communication with the memory, the computing device being configured to at least: generate an outcome of a wagering game comprising a plurality of indicia; determine that a particular combination of indicia of the plurality of indicia are positioned along a payline; in response to determining that a particular combination of indicia is positioned along the pay line, render a second plurality of indicia comprising at least two indicia corresponding to one indicium in the particular combination of indicia from the wagering game; receive a selection of a particular indicium of the second plurality of indicia; and in response to determining that the particular indicium being one of the at least two indicia, render a user interface indicating a matching of the at least two indicia and award a matching bonus.

Clause 2. The system of clause 1 or any other clause herein, wherein the at least two indicia comprise three indicia.

Clause 3. A non-transitory computer-readable medium embodying a program that, when executed by at least one computing device, causes the at least one computing device to: generate an outcome of a wagering game comprising a plurality of indicia; determine that the outcome of the wagering game comprises a particular combination of indicia; in response to determining a particular combination of indicia, render a second plurality of indicia comprising at least two indicia corresponding to one indicium in the particular combination of indicia from the wagering game; receive a selection of one of the second plurality of indicia; and in response to receiving the selection, render a user interface indicating a matching of the at least two indicia and award a matching bonus.

Clause 4. A method, comprising: generating, via at least one computing device, an outcome of a wagering game comprising a plurality of indicia; determining, via the at least one computing device, that a particular combination of indicia of the plurality of indicia are positioned along a pay line; in response to determining a particular combination of indicia are positioned along the pay line, rendering, via the at least one computing device, a matching game comprising a second plurality of indicia comprising at least two indicia corresponding to one indicium in the particular combination of indicia from the wagering game; receiving a selection of one of the second plurality of indicia; and rendering, via the at least one computing device, a user interface showing a matching of the at least two indicia in response to the selection.

Clause 5. The method of clause 4 or any other clause herein, further comprising rendering, via the at least on computing device, a second matching game, the second matching game involving selecting one matching indicium to generate a matching award.

Clause 6. The method of clause 5 or any other clause herein, further comprising awarding a bet amount back to a user in response to selecting one matching indicium.

Clause 7. The method of clause 6 or any other clause herein, wherein receiving the selection of one of the second plurality of indicia results in an incorrect match.

Clause 8. A system, comprising: a memory; and a computing device in communication with the memory, the computing device being configured to at least: generate an outcome of a wagering game comprising a plurality of indicia; determine that a particular combination of indicia of the plurality of indicia are positioned along a pay line; indicate a subset of the particular combination of indicia; receive a selection of at least two indicia of the subset of the particular combination of indicia; render a second plurality of indicia comprising at least two indicia corresponding to one indicium in the particular combination of indicia from the wagering game; receive a selection of a particular indicium of the second plurality of indicia; and in response to the particular indicium being one of the at least two indicia of the second plurality of indicia, render a user interface indicating a matching of the at least two indicia of the second plurality of indicia and award a matching award.

Clause 9. The system of clause 8 or any other clause herein, wherein the second plurality of indicia is rendered in response to the at least two indicia selected failing to match each other.

Clause 10. The system of clause 9 or any other clause herein, wherein the matching award comprises a percentage of the bet amount.

Clause 11. The system of clause 10 or any other clause herein, wherein the percentage is between 80%-120%.

Clause 12. The system of clause 8 or any other clause herein, wherein the second plurality of indicia is rendered in response to the at least two indicia selected matching each other.

Clause 13. The system of clause 8 or any other clause herein, wherein the matching award comprises any one of an amount of award credit, an amount of currency, or a free wagering game.

Clause 14. The system of clause 8 or any other clause herein, wherein the plurality of indicia comprises a plurality of animations.

Clause 15. The system of clause 8 or any other clause herein, wherein the computing device is further configured to: iteratively generate a plurality of trial outcomes until an outcome is generated where no winning combination is achieved.

Clause 16. The system of clause 8 or any other clause herein, wherein the computing device is further configured to increment one or more meters for counting a quantity of matching awards awarded.

Clause 17. The system of clause 8 or any other clause herein, wherein the computing device is further configured to encode the matching award into a scannable media.

Clause 18. The system of clause 16 or any other clause herein, wherein the computing device is further configured to transmit an indication of the matching award to a gaming service, the gaming service records the quantity of the matching awards awarded to a user account.

Clause 19. The system of clause 8 or any other clause herein, wherein the user interface comprises a rendering of a pay table.

Clause 20. The system of clause 8 or any other clause herein, wherein the outcome of the wagering game is associated with an indicia matching game feature, a bonus game, or an amount of award credit.

A phrase, such as “at least one of X, Y, or Z,” unless specifically stated otherwise, is to be understood with the context as used in general to present that an item, term, etc., can be either X, Y, or Z, or any combination thereof (e.g., X, Y, and/or Z). Similarly, “at least one of X, Y, and Z,” unless specifically stated otherwise, is to be understood to present that an item, term, etc., can be either X, Y, and Z, or any combination thereof (e.g., X, Y, and/or Z). Thus, as used herein, such phrases are not generally intended to, and should not, imply that certain embodiments require at least one of either X, Y, or Z to be present, but not, for example, one X and one Y. Further, such phrases should not imply that certain embodiments require each of at least one of X, at least one of Y, and at least one of Z to be present.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present disclosure defined in the following claims, the scope of which are to be accorded the broadest interpretation so as to encompass modifications and equivalent structures.

Therefore, at least the following is claimed:

1. A system, comprising:
a memory; and
a computing device in communication with the memory, the computing device being configured to at least:
generate an outcome of a wagering game comprising a plurality of indicia;
determine that a particular combination of indicia of the plurality of indicia are positioned along a payline;
in response to determining that a particular combination of indicia is positioned along a pay line, render a second plurality of indicia comprising at least two indicia corresponding to one indicium in the particular combination of indicia from the wagering game;
receive a selection of a particular indicium of the second plurality of indicia; and
in response to determining that the particular indicium being one of the at least two indicia, render a user interface indicating a matching of the at least two indicia and award a matching bonus.

2. The system of claim 1, wherein the at least two indicia comprise three indicia.

3. A method, comprising:
generating, via at least one computing device, an outcome of a wagering game comprising a plurality of indicia;
determining, via the at least one computing device, that a particular combination of indicia of the plurality of indicia are positioned along a pay line;
in response to determining a particular combination of indicia are positioned along the pay line, rendering, via the at least one computing device, a matching game comprising a second plurality of indicia comprising at least two indicia corresponding to one indicium in the particular combination of indicia from the wagering game;
receiving a selection of one of the second plurality of indicia; and
rendering, via the at least one computing device, a user interface showing a matching of the at least two indicia in response to the selection.

4. The method of claim 3, further comprising rendering, via the at least on computing device, a second matching game, the second matching game involving selecting one matching indicium to generate a matching award.

5. The method of claim 4, wherein the matching award comprises a percentage of a bet amount.

6. The method of claim 4, further comprising awarding a bet amount back to a user in response to selecting one matching indicium.

7. The method of claim 6, wherein receiving the selection of one of the second plurality of indicia results in an incorrect match.

8. A system, comprising:
a memory; and
a computing device in communication with the memory, the computing device being configured to at least:
generate an outcome of a wagering game comprising a plurality of indicia;
determine that a particular combination of indicia of the plurality of indicia are positioned along a pay line;
indicate a subset of the particular combination of indicia;
receive a selection of at least two indicia of the subset of the particular combination of indicia;
render a second plurality of indicia comprising at least two indicia corresponding to one indicium in the particular combination of indicia from the wagering game;
receive a selection of a particular indicium of the second plurality of indicia; and
in response to the particular indicium being one of the at least two indicia of the second plurality of indicia, render a user interface indicating a matching of the at least two indicia of the second plurality of indicia and award a matching award.

9. The system of claim 8, wherein the second plurality of indicia is rendered in response to the at least two indicia selected failing to match each other.

10. The system of claim 9, wherein the matching award comprises a percentage of a bet amount.

11. The system of claim 10, wherein the percentage is between 80%-120%.

12. The system of claim 8, wherein the second plurality of indicia is rendered in response to the at least two indicia selected matching each other.

13. The system of claim 8, wherein the matching award comprises any one of an amount of award credit, an amount of currency, or a free wagering game.

14. The system of claim 8, wherein the plurality of indicia comprises a plurality of animations.

15. The system of claim 8, wherein the computing device is further configured to iteratively generate a plurality of trial outcomes until an outcome is generated where no winning combination is achieved.

16. The system of claim 8, wherein the computing device is further configured to increment one or more meters for counting a quantity of matching awards awarded.

17. The system of claim 8, wherein the computing device is further configured to encode the matching award into a scannable media.

18. The system of claim 16, wherein the computing device is further configured to transmit an indication of the matching award to a gaming service, the gaming service records the quantity of the matching awards awarded to a user account.

19. The system of claim 8, wherein the user interface comprises a rendering of a pay table.

20. The system of claim 8, wherein the outcome of the wagering game is associated with an indicia matching game feature, a bonus game, or an amount of award credit.
